(19) United States
(12) Patent Application Publication
(10) Pub. No.: US 2026/0311411 A1
(43) Pub. Date: Oct. 8, 2026

(54) ON-DEVICE MULTI-MODAL AI WITH SYNCHRONIZED FACE AND FULL-BODY ANIMATION FOR 3D VIRTUAL ASSISTANTS

(71) Applicant: Samsung Electronics Co., Ltd., Suwon-si (KR)

(72) Inventors: Byeonghee Yu, Fremont, CA (US); Kun Jin, San Jose, CA (US); Srinivasa Reddy Algubelli, Fremont, CA (US); Siva Penke, San Jose, CA (US)

(21) Appl. No.: 19/305,538

(22) Filed: Aug. 20, 2025

Related U.S. Application Data
(60) Provisional application No. 63/783,005, filed on Apr. 3, 2025.

(51) Int. Cl. G06T 13/20; G06F 40/242; G06F 40/40; G06T 13/40; G10L 13/02; G10L 13/08; G10L 15/02

(52) U.S. Cl. CPC G06T 13/205; G06F 40/242; G06F 40/40; G06T 13/40; G10L 13/02; G10L 13/08; G10L 15/02; G10L 2015/025

(57) ABSTRACT

Multi-modal artificial intelligence (AI) generation of synchronized face and full-body animation for a three-dimensional (3D) avatar includes obtaining input audio and text data, extracting audio features, and extracting emotion features using a multilingual language model trained to classify emotion type and corresponding intensity from text. A facial expression generation model predicts phonemes, phoneme/word boundaries for lip-sync activity, facial blendshape weights for facial expressions, iris movements and eye blink activity for eye movements, and/or orientation of a neck joint for avatar head movements. Final facial blendshape weights for a specified facial expression are determined based on the predicted phonemes, facial blendshape weights and/or the emotion features. A gesture generation model predicts a 3D position of a body center and orientation of body joints. Final 3D full-body animation keyframes of avatar body gestures, synchronizing body motion intensity with lip-sync activity, and final facial blendshape weights are presented synchronously with corresponding audio.

### CROSS-REFERENCE TO RELATED APPLICATION AND CLAIM OF PRIORITY

This application claims priority under 35 U.S.C. § 119(e) to U.S. Provisional Patent Application No. 63/783,005 filed on Apr. 3, 2025, which is hereby incorporated by reference in its entirety.

### TECHNICAL FIELD

This disclosure relates generally to virtual assistant systems and processes. More specifically, this disclosure relates to on-device multi-modal artificial intelligence (AI) with synchronized face and full-body animation for three-dimensional (3D) virtual assistants.

### BACKGROUND

User demand for an on-device three-dimensional (3D) virtual assistant is increasing, especially when an avatar is powered by outputs from on-device large language models (LLMs). However, most current technologies face several significant challenges, particularly in generating face and full-body animations for a 3D avatar. Key challenges can include the absence of emotional expressions, unnatural reactions, and poor synchronization between face and body motions.

### SUMMARY

This disclosure relates to on-device multi-modal artificial intelligence (AI) with synchronized face and full-body animation for three-dimensional (3D) virtual assistants.

In a first embodiment, a method includes obtaining, using at least one processing device of an electronic device, input audio data and input text data. The method also includes extracting, using the at least one processing device, audio features from the input audio data using an audio encoder. The method further includes extracting, using the at least one processing device, emotion features for the input text data using a multilingual language model trained to classify emotion type and emotion intensity from text. The method also includes providing, using the at least one processing device, the audio features to a facial expression generation model trained to predict at least one of phonemes, phoneme/word boundaries for lip-sync activity, facial blendshape weights for facial expressions, iris movements and eye blink activity for eye movements, and orientation of a neck joint for head movements of an avatar. The method further includes determining, using the at least one processing device, final facial blendshape weights for a specified facial expression of the avatar based on at least one of the predicted phonemes, the predicted facial blendshape weights, and the emotion features. The method also includes providing, using the at least one processing device, the audio features and the emotion features to a gesture generation model trained to predict at least one of a 3D position of a body center and orientation of body joints. The method further includes generating, using the at least one processing device, final 3D full-body animation keyframes of body gestures of the avatar based on at least one of the predicted phoneme/word boundaries, the predicted 3D position of the body center, and the predicted orientation of the body joints. In addition, the method includes playing, using the at least one processing device, the input audio data and synchronously presenting the final facial blendshape weights and the final 3D full-body animation keyframes.

In a second embodiment, an electronic device includes at least one processing device configured to obtain input audio data and input text data, extract audio features from the input audio data using an audio encoder, and extract emotion features for the input text data using a multilingual language model trained to classify emotion type and emotion intensity from text. The at least one processing device is also configured to provide the audio features to a facial expression generation model trained to predict at least one of phonemes, phoneme/word boundaries for lip-sync activity, facial blendshape weights for facial expressions, iris movements and eye blink activity for eye movements, and orientation of a neck joint for head movements of an avatar. The at least one processing device is further configured to determine final facial blendshape weights for a specified facial expression of the avatar based on at least one of the predicted phonemes, the predicted facial blendshape weights, and the emotion features. The at least one processing device is also configured to provide the audio features and the emotion features to a gesture generation model trained to predict at least one of a 3D position of a body center and orientation of body joints. The at least one processing device is further configured to generate final 3D full-body animation keyframes of body gestures of the avatar based on at least one of the predicted phoneme/word boundaries, the predicted 3D position of the body center, and the predicted orientation of the body joints. In addition, the at least one processing device is configured to play the input audio data and synchronously presenting the final facial blendshape weights and the final 3D full-body animation keyframes.

Any single one or any combination of the following features may be used with the first or second embodiment. A selection of an application mode may be received from a user. In a first application mode, the input audio data may include user-provided audio, and the input text data may be generated from the user-provided audio using automatic speech recognition (ASR). In a second application mode, the input text data may include user-provided text, and the input audio data may be generated from the user-provided text using text-to-speech (TTS). In a third application mode, the input text data may include a text response to a user inquiry from an on-device large language model (LLM), and the input audio data may be generated from the text response using TTS.

A selection for an avatar mode may be received from the user. A first avatar mode may correspond to 3D avatar animation for only a head of the avatar, and the facial expression generation model may be trained to generate final 3D head animation keyframes based on the predicted orientation of the neck joint and the gesture generation model may be disabled in the first avatar mode. A second avatar mode may correspond to 3D avatar animation for the head and an upper body of the avatar, and the predicted orientation of the neck joint from the facial expression model may be overwritten by the orientation of all body joints, including the head and neck, predicted by the gesture generation model in the second avatar mode. A third avatar mode may correspond to 3D avatar animation for the head and a full body of the avatar, and the predicted orientation of the neck joint from the facial expression model may be overwritten by the orientation of all body joints, including the head and neck, predicted by the gesture generation model in the third avatar mode.

The final facial blendshape weights of the avatar may be determined and the final 3D full-body animation keyframes may be generated by synchronizing body motion intensity with the lip-sync activity.

The facial expression generation model and the gesture generation model may be trained using audio features from a common audio encoder based on a synchronized dataset including facial expressions corresponding to the phonemes and the facial blendshape weights, body gestures corresponding to 3D animation keyframes, and corresponding audio and text. The body motion intensity may be synchronized with the lip-sync activity by synchronizing body gesture speeds with the predicted phoneme/word boundaries and generating facial expressions and body gestures at a common frame rate adjustable by a user.

The emotion features for the input text data may be extracted by filtering emotion lexicons from the input text data using a pre-defined dictionary; predicting emotion types and emotion intensities of the emotion lexicons; and distributing the emotion types and emotion intensities across the animation keyframes at a user-specified frame rate.

The predicted facial blendshape weights may be first facial blendshape weights, and the specified facial expression of the avatar may be generated by predicting the phonemes, phoneme/word boundaries, and corresponding confidence scores from the audio features; converting the predicted phonemes into second facial blendshape weights; converting the emotion types and emotion intensities into third facial blendshape weights; and determining the final facial blendshape weights based on an adaptive weighted sum of the first facial blendshape weights, the second facial blendshape weights, and the third facial blendshape weights.

The gesture generation model may be configured to predict encoded avatar motion from the audio features and an encoded style from the emotion types and emotion intensities; use the encoded avatar motion to generate raw 3D full-body animation keyframes of the body gestures of the avatar; and condition motion generation based on the encoded style.

The input text data may include a text response to a user inquiry from an on-device LLM. The input text data may be received in a voice input mode or a text input mode. In the voice input mode, the user inquiry may be received via voice input; the avatar may be presented in a listening mode in response to detecting voice activity of a user; an end of the user inquiry may be detected in response to detecting voice inactivity of the user; the voice input may be converted into text using ASR, the text may be forwarded to the on-device LLM, and the text response may be received from the on-device LLM. In the text input mode, the user inquiry may be received via text input; the text input may be forwarded to the on-device LLM; and the text response may be received from the on-device LLM.

The voice activity of the user may be detected by predicting phonemes with confidence scores by inputting the voice activity of the user into the facial expression generation model and determining if non-silence phonemes are predicted above a confidence threshold. The listening mode for the avatar may include presenting a predetermined idle avatar animation during the voice inactivity by the user; presenting a predetermined listening avatar animation during the voice activity of the user; and interpolating between the predetermined idle avatar animation and the predetermined listening avatar animation during the voice inactivity by the user and the voice activity of the user.

The electronic device may include at least one of: a mobile device, an extended reality (XR) device, or a robot.

A non-transitory machine-readable medium may contain instructions that when executed cause at least one processor of an electric device to perform the method of the first embodiment, optionally with any one or any combination of the features described above.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B”, “at least one of A and B”, and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for”, “having the capacity to”, “designed to”, “adapted to”, “made to”, or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism”, “module”, “device”, “unit”, “component”, “element”, “member”, “apparatus”, “machine”, “system”, “processor”, or “controller”, within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration that may be employed for multi-modal artificial intelligence (AI) generation of synchronized face and full-body animation for a three-dimensional (3D) avatar in accordance with this disclosure;

FIG. 2 illustrates an example process of on-device multi-modal AI generation of synchronized face and full-body animation for a 3D avatar in accordance with this disclosure;

FIG. 3 illustrates an example pipeline for on-device multi-modal AI generation of synchronized face and full-body animation for a 3D avatar in accordance with this disclosure;

FIG. 4 illustrates an example input and pre-processing stage of FIG. 3 in greater detail together with a portion of a platform for avatar expression in accordance with this disclosure;

FIG. 5 illustrates example portions of the input and pre-processing stage and the platform for avatar expression of FIGS. 3 and 4 for explanation of activation of an avatar listening mode in accordance with this disclosure;

FIG. 6 illustrates example portions of a machine learning (ML)-powered processing stage of FIG. 3 in greater detail for summarizing avatar animation in accordance with this disclosure;

FIG. 7 illustrates example synchronization between facial expressions (including lip-sync) and body gestures in accordance with this disclosure;

FIG. 8 illustrates example gesture generation model post-processing in FIG. 6 in greater detail for explaining how synchronization between facial expressions and body gestures can be achieved in accordance with this disclosure;

FIG. 9 illustrates example training dataset collection for joint training of machine learning models to achieve synchronization between facial expressions and body gestures in accordance with this disclosure;

FIG. 10 illustrates an example process for model preparation for the platform for avatar expression in accordance with this disclosure;

FIG. 11 illustrates example performance of the multilingual language model of FIG. 3 in accordance with this disclosure;

FIG. 12 illustrates example post-processing by the voice processing network of FIG. 3 in greater detail in accordance with this disclosure;

FIG. 13 illustrates an example phoneme-blendshape mapping table in accordance with this disclosure;

FIG. 14 illustrates an example of blending based on blendshape weights in accordance with this disclosure;

FIGS. 15 and 15A-15C illustrate an example gesture generation engine of FIG. 3 in greater detail in accordance with this disclosure;

FIGS. 16A and 16B illustrate example modes of operation for the platform for avatar expression in FIG. 3 in accordance with this disclosure; and

FIG. 17 illustrates example use cases for on-device multi-modal AI generation of synchronized face and full-body animation for a 3D avatar in accordance with this disclosure.

### DETAILED DESCRIPTION

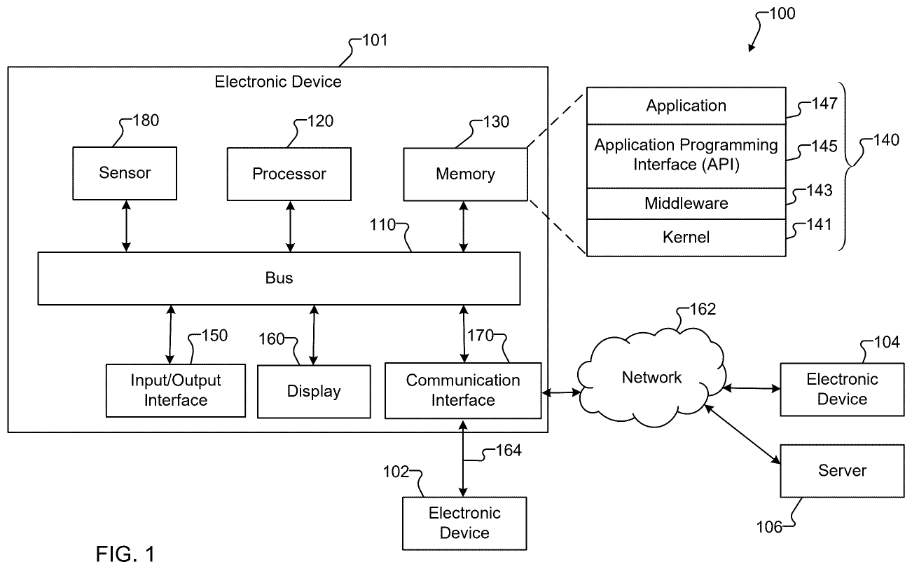

FIGS. 1 through 17, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, user demand for an on-device three-dimensional (3D) virtual assistant is increasing, especially when an avatar is powered by outputs from on-device large language models (LLMs). However, most current technologies face several significant challenges, particularly in generating face and full-body animations for a 3D avatar. Key challenges can include the absence of emotional expressions, unnatural reactions, and poor synchronization between face and body motions.

This disclosure provides various techniques for on-device multi-modal artificial intelligence (AI) with synchronized face and full-body animation for 3D virtual assistants. Among other things, an on-device machine learning (ML) framework can generate synchronized face and body animations that align with emotions conveyed in an avatar's speech. End-to-end generation of synchronized facial expressions (including lip-sync) and body gestures for either audio (voice) or text input is disclosed, as well as a light-weight pipeline that processes in both non-real-time (NRT) and real-time (RT) modes and can be easily deployable on mobile devices or other devices.

FIG. 1 illustrates an example network configuration 100 that may be employed for multi-modal AI generation of synchronized face and full-body animation for a 3D avatar in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform various operations related to multi-modal AI generation of synchronized face and full-body animation for a 3D avatar.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to multi-modal AI generation of synchronized face and full-body animation for a 3D avatar. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an extended reality (XR) device, which includes a virtual reality (VR) headset or an augmented reality (AR) wearable device, such as eyeglasses that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to multi-modal AI generation of synchronized face and full-body animation for a 3D avatar.

Although FIG. 1 illustrates one example of a network configuration 100 that may be employed for agentic AI-based cybersecurity zero-day vulnerability detection and mitigation, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

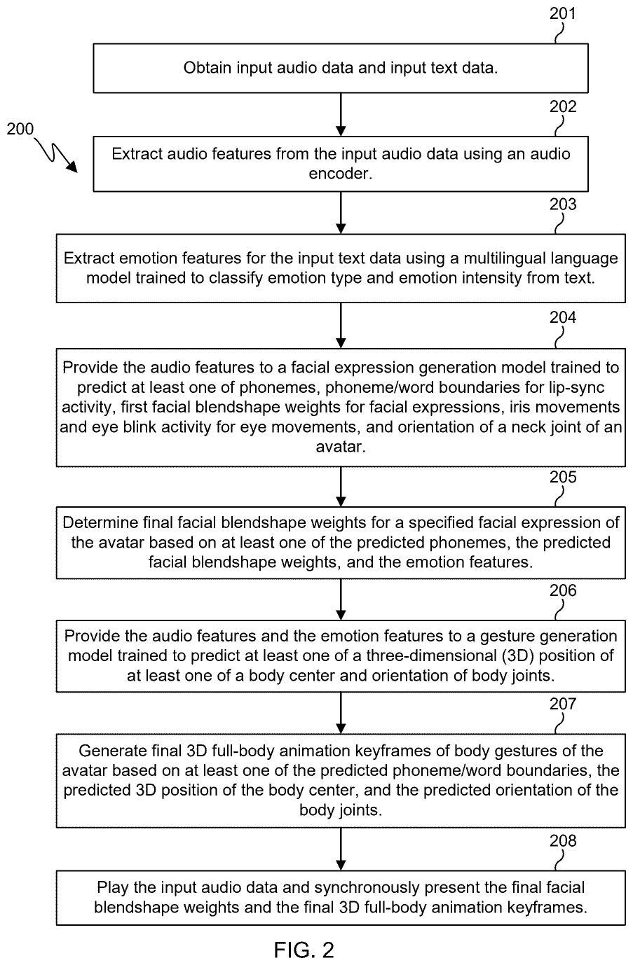

FIG. 2 illustrates an example process 200 of on-device multi-modal AI generation of synchronized face and full-body animation for a 3D avatar in accordance with this disclosure. For ease of explanation, the process 200 of FIG. 2 is described as being performed using the electronic device 101 in the network configuration 100 of FIG. 1. However, the process 200 may be performed using any other suitable device(s) (such as the server 106) and in any other suitable system(s).

As shown in FIG. 2, the process 200 begins with obtaining input audio data and input text data (step 201). In some cases, the input audio data may be voice input for a user or synthetic speech for a virtual assistant. Also, in some cases, the input text data may be text typed by the user, a transcript of speech by the user, or a response by a virtual assistant. Audio features are extracted from the input audio data using an audio encoder (step 202). For example, the audio features may include mel frequency cepstral coefficients (MFCCs) and prosodic features, such as speech intensity or pitch and corresponding derivatives (of intensity or pitch). Emotion features for the input text data are extracted using a multilingual language model trained to classify emotion type and emotion intensity from text (step 203). For instance, the emotion features may correspond to specified types of emotions, such as joy, love, surprise, sadness, fear, or anger or may correspond to a neutral (absence of) emotion, along with the intensity of each emotion.

The audio features are provided to a facial expression generation model trained to predict at least one of phonemes, phoneme/word boundaries for lip-sync activity, first facial blendshape weights for facial expressions, iris movements and eye blink activity for eye movements, and orientation of a neck joint of an avatar (step 204). In some cases, the audio features may be used to synchronize avatar animation with audio to be played with presentation of the avatar. Final facial blendshape weights for a specified facial expression of the avatar are determined based on at least one of the predicted phonemes, the predicted (first) facial blendshape weights and the emotion features (step 205). For example, the final facial blendshape weights may correspond to the mouth shape of phonemes blended with the facial characteristics of an emotion. The audio features and the emotion features are provided to a gesture generation model trained to predict at least one of a 3D position of a body center and orientation of body joints (step 206). In some cases, this step may be optional if head-only animation is being presented or may be limited (such as to just body joints) if animation of only the torso is being presented.

Final 3D full-body animation keyframes of body gestures of the avatar are generated based on at least one of the predicted phoneme/word boundaries, the predicted 3D position of the body center, and the predicted orientation of the body joints (step 207). For example, at least the facial expression and neck orientation can be used for all modes of avatar animation, while other modes may not utilize all parts of the full-body animation keyframes. The input audio data is played synchronously with presentation of the final facial blendshape weights and the final 3D full-body animation keyframes (step 208). For instance, the presentation may correspond to an avatar for the user in a video conference or similar environment or may correspond to an avatar for a virtual assistant.

Although FIG. 2 illustrates one example of a process 200 of on-device multi-modal AI generation of synchronized face and full-body animation for a 3D avatar, various changes may be made to FIG. 2. For example, while shown as a series of steps, various steps in FIG. 2 could overlap, occur in parallel, occur in a different order, or occur any number of times (including zero times).

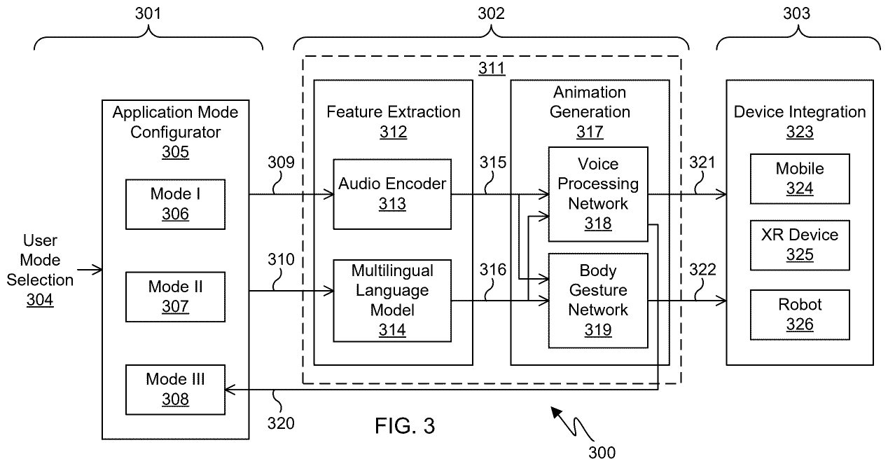

FIG. 3 illustrates an example pipeline 300 for on-device multi-modal AI generation of synchronized face and full-body animation for a 3D avatar in accordance with this disclosure. For ease of explanation, the pipeline 300 of FIG. 3 is described as being implemented within the server 106 (during training) and the electronic device 101 (during inferencing) in the network configuration 100 of FIG. 1. However, the pipeline 300 may be implemented using any other suitable device(s) and in any other suitable system(s).

As shown in FIG. 3, the pipeline 300 includes three general stages, namely an input and pre-processing stage 301, an ML-powered processing stage 302, and an output rendering stage 303. The input and pre-processing stage 301 generally operates to receive a user mode selection 304 at an application mode configurator 305. In some cases, the pipeline 300 may support multiple modes. For example, in mode I 306, the user is represented as a 3D virtual avatar using his or her voice as an input. In mode II 307, the user is represented as a 3D virtual avatar using his or her text as an input. In mode III 308, the user asks questions of an AI virtual assistant (such as via voice or text), and the AI virtual assistant responds with an avatar powered by LLM-generated output. In each mode, the user or AI virtual assistant avatar can be presented with at least voice and face animations synchronized and optionally also with synchronized body animations. Note, however, that other or additional modes may be used here.

In the input and pre-processing stage 301, the pipeline 300 receives a user mode selection 304 for the application from a user and configures the pipeline 300 accordingly into one of the application modes (such as mode I 306, mode II 307, or mode III 308). Depending on the selected mode, the application mode configurator 305 may request input audio (voice) or input text from the user. If user audio is requested, input audio may be converted to a corresponding text transcript. If user text is requested, input text may be converted to a corresponding synthetic audio.

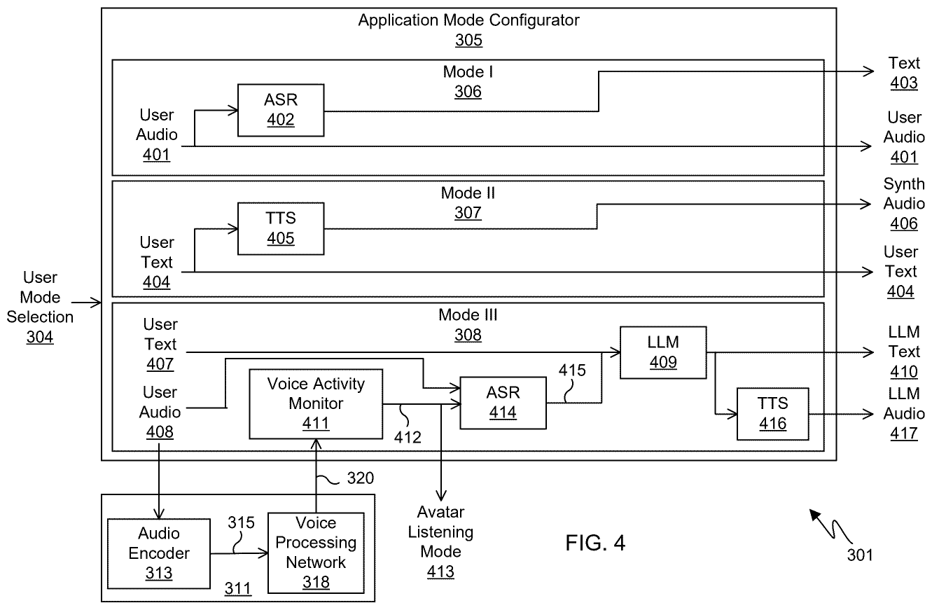

FIG. 4 illustrates an example input and pre-processing stage 301 of FIG. 3 in greater detail together with a portion of a platform 311 for avatar expression in accordance with this disclosure. For ease of explanation, the input and pre-processing stage 301 is described as being implemented within the server 106 (during training) and the electronic device 101 (during inferencing) in the network configuration 100 of FIG. 1. However, the input and pre-processing stage 301 may be implemented using any other suitable device(s) and in any other suitable system(s).

As shown in FIG. 4, for mode I 306, the input and pre-processing stage 301 receives user audio 401 provided by the user as an input for delivery in synchronization with a user avatar. Automatic speech recognition (ASR) 402 processes the user audio 401 to generate a transcript text 403. For mode II 307, the input and pre-processing stage 301 receives user text 404 provided by the user as an input for delivery as speech by the user avatar. Text-to-speech (TTS) 405 processes the user text 404 to generate synthetic audio 406. For mode III 308, the input and pre-processing stage 301 receives a user inquiry in the form of user text 407 or user audio 408.

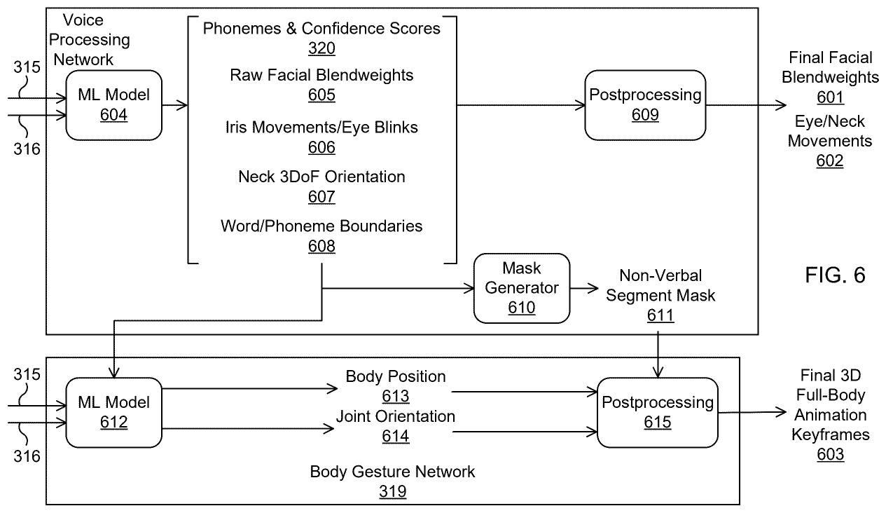

When the user inquiry is in the form of user text 407, the user text 407 can be processed by an LLM 409 to generate an LLM response 410 in text form. When the user inquiry is in the form of user audio 408, the user audio 408 can be processed by an audio encoder 313 and a voice processing network 318 (such as a facial generation model) to generate, respectively, audio features 315 and phonemes and associated confidence scores 320 as input for a voice activity monitor 411. In some embodiments, the voice processing network 318 may be implemented as described in U.S. Pat. No. 12,154,204 or U.S. Patent Application Publication No. 2024/0203014, the contents of which are hereby incorporated by reference in their entirety. Additional details of the structure and operation of the voice processing network 318 are depicted in FIG. 6 and discussed below.

The voice activity monitor 411 uses the phonemes and confidence scores 320 to detect user voice activity 412. When detected, the user voice activity 412 can be employed to present the AI voice assistant avatar in a listening mode 413. Detected user voice activity 412 may also be used to activate ASR 414 in order to generate text 415 corresponding to a user inquiry. The text 415 can be processed by the LLM 409 to generate an LLM response 410 in text form. The LLM response 410 in text form can be processed by TTS 416 in order to generate a corresponding LLM audio 417.

During operation of the input and pre-processing stage 301 in mode I 306, the user audio 401 is requested as an input and converted to the transcript text 403, such as by an on-device ASR 402. The application mode configurator 305 feeds both the user audio 401 (unchanged from the input) and the transcript text 403 (the input user audio 401 converted to text by the ASR 402) as inputs to the platform 311 for avatar expression. Additional details of the structure and operation of the application mode configurator 305 are depicted in FIG. 4 and are discussed below.

During operation of the input and pre-processing stage 301 in mode II 307, the user text 404 is requested as an input and converted to a synthetic audio 406, such as by an on-device TTS 405. The application mode configurator 305 feeds both the synthetic audio 406 (the input user text 404 converted to audio by the TTS 405) and the user text 404 (unchanged from the input) as inputs to the platform 311 for avatar expression.

During operation of the input and pre-processing stage 301 in mode III 308, the user makes an inquiry to the LLM 409, such as via the user text 407 or the user audio 408 (voice). If the user makes the inquiry via the user text 407, the user inquiry can be fed in text form, such as to an on-device LLM 409. The LLM response 410, in text form in the example shown, can be converted to (synthetic) LLM audio 417, such as by the on-device TTS 416. The application mode configurator 305 feeds both the LLM response 410 and the LLM audio 417 as inputs to the platform 311 for avatar expression.

If the user makes the inquiry to the LLM 409 via the user audio 408, the audio stream is fed to components in the platform 311 for avatar expression, namely the audio encoder 313 and the voice processing network 318. The audio encoder 313 takes the input audio stream and extracts audio features 315. The voice processing network 318 takes the audio features 315 as inputs and generates phonemes and corresponding confidence scores 320. Given those phonemes and corresponding confidence scores 320, the voice activity monitor 411 determines if there is user voice activity 412.

The avatar listening mode 413 is presented to the user if voice activity 412 is detected. For example, when the voice activity 412 falls below a threshold for a specified duration, the voice activity monitor 411 can infer that a user inquiry has ended and convert the entire user audio 408 for the voice inquiry into text 415, such as by an on-device ASR 414. The converted text 415 is fed to the on-device LLM 409, and the LLM response 410 to the user inquiry is converted to LLM audio 417, such as by the on-device TTS 416. The application mode configurator 305 feeds both the LLM response 410 and the corresponding LLM audio 417 responsive to the user inquiry as inputs to portions of the platform 311 for avatar expression other than audio encoder 313 and voice processing network 318.

Referring back to FIG. 3, the outputs of the input and pre-processing stage 301 (such as from the application mode configurator 305) can include the input audio 309 and the input text 310, which are received by the ML-powered processing stage 302 at the platform 311 for avatar expression. Depending on the application mode selected, the input audio 309 may be user audio 401 for the user avatar, synthetic audio 406 for the user avatar, or (synthetic) LLM audio 417 for the AI virtual assistant avatar. The text 310 may be text 403 corresponding to user audio 401 for use with the user avatar, user text 404 for use with the user avatar, or the LLM response to the user inquiry for presentation through the AI virtual assistant avatar.

The platform 311 for avatar expression can contain various on-device ML models for audio and text processing. For example, the platform 311 may include models for feature extraction 312 and models for animation generation 317. The models for feature extraction 312 can include the audio encoder 313 and a multilingual language model 314. The audio encoder 313 represents an on-device ML model that extracts audio features 315 from input audio 309. The multilingual language model 314 represents an on-device ML model that can be trained to identify emotion type. In some cases, the multilingual language model 314 may be implemented by an on-device bilingual language model (LM) that classifies emotions and intensities from input text. In some cases, supported emotions may include joy, love, neutral, surprise, sadness, fear, or anger, and the intensity types may include low, medium, and high. The models for animation generation 317 can include the voice processing network 318 (which performs facial expression generation and predicts facial blendshape weights 321 for face animation, as well as eye/neck movements, from the input audio features 315 and the emotion features 316) and a body gesture network 319, such as a gesture generation model (which performs body gesture generation and predicts 3D full-body animation keyframes 322 for body animation from input audio features 315 and the emotion features 316). In some embodiments, the body gesture network 319 may be implemented as described in U.S. patent application Ser. No. 19/175,966 filed on Apr. 10, 2025, the contents of which are hereby incorporated by reference in their entirety. Additional details of the structure and operation of the body gesture network 319 are depicted in FIG. 6, and are discussed below.

The final outputs are facial blendshape weights 321 and 3D full-body animation keyframes 322 for a 3D AI avatar. In the output rendering stage 303, the outputs of the platform 311 for avatar expression may be integrated during device integration 323 into any of a variety of devices, such as mobile phones 324, XR devices 325, and robots 326. The output rendering stage 303 can be used to present either the user or an AI virtual assistant with synchronized facial and body expressions.

Although FIG. 3 illustrates one example of a pipeline 300 for on-device multi-modal AI generation of synchronized face and full-body animation for a 3D avatar, various changes may be made to FIG. 3. For example, various components or functions shown in FIG. 3 may be combined, further subdivided, replicated, omitted, or rearranged and additional components may be added according to particular needs. Also, feature extraction may be performed separately during application mode configuration and within the platform 311 for avatar expression, since different feature information may be required or sufficient for the respective subsystems. Although FIG. 4 illustrates one example of the input and pre-processing stage 301 of FIG. 3 in greater detail together with a portion of the platform 311 for avatar expression, various changes may be made to FIG. 4. For instance, various components or functions shown in FIG. 4 may be combined, further subdivided, replicated, omitted, or rearranged and additional components may be added according to particular needs. In addition, while ASR 402 and ASR 414 are depicted as distinct and TTS 405 and TTS 416 are depicted as distinct, the ASR and/or TTS functionality may be implemented by a single module that is activated based on the user mode selection 304. Similarly, separate inputs for user audio 401 and user audio 408 and for user text 404 and user text 407 need not be provided but may be implemented as a single input with routing controlled according to the user mode selection 304.

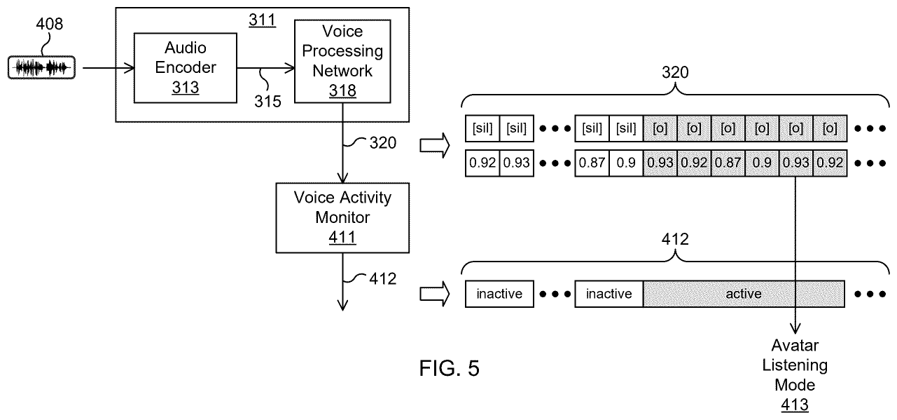

FIG. 5 illustrates example portions of the input and pre-processing stage 301 and the platform 311 for avatar expression of FIGS. 3 and 4 for explanation of activation of an avatar listening mode in accordance with this disclosure. For ease of explanation, activation of the avatar listening mode is described as being implemented within the electronic device 101 in the network configuration 100 of FIG. 1. However, the feature may be implemented using any other suitable device(s) and in any other suitable system(s).

If the pipeline 300 receives the user audio 408 (depicted here as a streaming audio input) for a user inquiry to the on-device LLM 409, the audio encoder 313 and the voice processing network 318 can predict phonemes and corresponding confidence scores 320, possibly in real-time. For example, if each box for a phoneme in FIG. 5 represents one animation frame, phonemes and confidence scores 320 can be predicted at 100 frames per second (fps) or once every 10 milliseconds (ms). In some cases, the processing time of the audio encoder 313 and the voice processing network 318 may be under about 10 ms for a 120 ms-long audio buffer for the user audio 408, which can make real-time processing feasible.

A transition from a silence phoneme (“[sil]”) to any valid phoneme (such as “[o]”) with high confidence suggests that the user has started speaking. The voice activity monitor 411 receives predicted phonemes and confidence scores 320 and determines the timing and duration of the user voice activity 412. If the top predicted phoneme is not the silence phoneme and the confidence score is above a specified threshold (such as 0.8), the voice activity monitor 411 can mark the frame as an active frame. If a set of active frames continues over a specified number of frames (such as 5 frames), the voice activity monitor 411 can determine that the user is speaking and initiate the avatar listening mode 413.

While the AI avatar is in avatar listening mode 413, a transition to the silence phoneme suggests that the user has stopped speaking. If the top predicted phoneme is the silence phoneme and the associated confidence score is above the threshold (such as 0.8), the voice activity monitor 411 can mark the frame as inactive frame. When inactive frames continue over a small number of frames, the avatar listening mode 413 can temporarily stop, and animations can be smoothly interpolated to an idle pose/motion for the AI avatar. If the sequence of inactive frames continues for a longer period of time (such as 3 seconds), the voice activity monitor 411 can conclude that the user has stopped speaking and convert an entire user voice inquiry into text 415, such as by using an on-device ASR 414.

While the user is speaking, the AI avatar can be presented in the avatar listening mode 413. In some cases, the avatar listening mode 413 may include upper-body avatar animation, such as one in which the AI avatar's head motion and facial expression give non-verbal hints to demonstrate that the avatar is attentively listening to the user inquiry. Example head motions may include slow rhythmic nodding motions (which can indicate acknowledgement and/or agreement) or tilting motions (which can indicate curiosity). Example facial expressions may include a mild smile demonstrating warm agreement, natural eye blinks, and somewhat-softened eyes and eyebrows.

Although FIG. 5 illustrates one example of portions of the input and pre-processing stage 301 and the platform 311 for avatar expression of FIGS. 3 and 4 for explanation of activation of an avatar listening mode, various changes may be made to FIG. 5. For example, the absence of the silence phoneme for a specified number of frames may be used to initiate the avatar listening mode 413 for the AI avatar.

FIG. 6 illustrates example portions of an ML-powered processing stage 302 of FIG. 3 in greater detail for summarizing avatar animation in accordance with this disclosure. For ease of explanation, the ML-powered processing stage 302 is described as being implemented within the server 106 (during training) and the electronic device 101 (during operation) in the network configuration 100 of FIG. 1. However, the input and pre-processing stage 301 may be implemented using any other suitable device(s) and in any other suitable system(s).

The voice processing network 318 and the body gesture network 319 within the platform 311 can each include one or more ML models for generating face animations and full-body avatar animations, respectively. Within the ML-powered processing stage 302, the voice processing network 318 can produce final facial blendshape weights 601 for face animations (as well as eye/neck movements 602), and the body gesture network 319 can produce final 3D full-body animation keyframes 603 for that avatar's body. An ML model 604 for the voice processing network 318 may be an end-to-end multilingual convolution acoustic model or other ML model that recognizes the phonemes and corresponding confidence scores 320, phoneme/word boundaries 608, raw facial blendshape weights 605, iris movements/eye blinks 606, neck movements (neck orientations 607, such as in three degrees-of-freedom (3DoF), for the neck joint).

Post-processing 609 can result in the generation of final facial blendshape weights 601 and the eye/neck movements 602. The outputs of the ML model 604 can be employed by a mask generator 610 to produce a non-verbal segment mask 611. An ML model 612 for the body gesture network 319, such as one implemented as a deep neural network (DNN) or other ML model, can produce body positions 613 and joint orientations 614, which can be employed by post-processing 615 in conjunction with the non-verbal segment mask 611 to produce the final 3D full-body animation keyframes 603. The operations performed by these components are described in further detail below.

Although FIG. 6 illustrates one example of portions of an ML-powered processing stage 302 of FIG. 3 in greater detail for summarizing avatar animation, various changes may be made to FIG. 6. For example, while the ML models 604 and 612 are depicted as separate, some overlap may exist for portions of the AI avatar (such as the neck and/or upper torso), or the ML models may be aligned with respect to such characteristics.

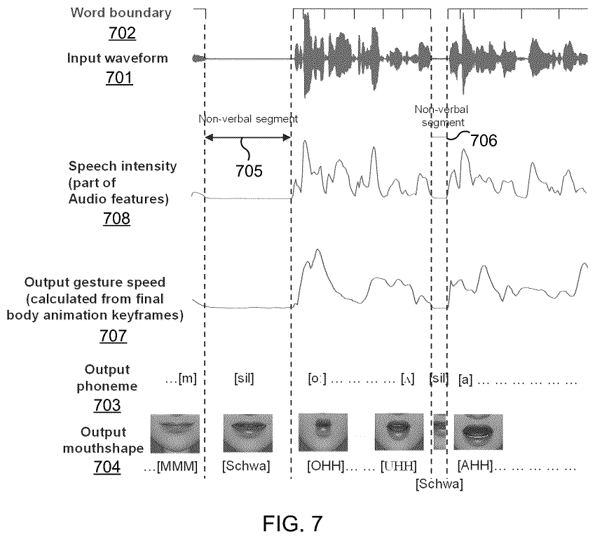

FIG. 7 illustrates example synchronization between facial expressions (including lip-sync) and body gestures in accordance with this disclosure. In general, viewers can be highly sensitive to misalignment in speech and face/body motion timing. Without proper synchronization, an AI avatar may look disjointed or robotic, reducing the realism and effectiveness.

FIG. 7 illustrates how an audio input waveform 701 for speech exhibits word boundaries 702 and phoneme boundaries 703. In order to reduce misalignment, an output mouth shape 704 for the AI avatar can align with the phoneme boundaries 703 and the word boundaries 702 while also reflecting non-verbal segments 705, 706. Also, the AI avatar's output gesture speed 707 can correspond to a speech intensity 708 of the audio input waveform 701. For example, the AI avatar's output body gesture speed can align with mouth movement such that, for instance, the avatar's body remains still when the avatar's mouth is still. Speech intensity 708 may be included among the audio features 315 predicted by the audio encoder 313 in the pipeline 300 of FIG. 3, and word boundaries 702 and phoneme boundaries 703 may be predicted and used by the voice processing network 318.

Although FIG. 7 illustrates one example of synchronization between facial expressions (including lip-sync) and body gestures, various changes may be made to FIG. 7. For example, the contents of FIG. 7 are examples only and can easily vary depending on the circumstances.

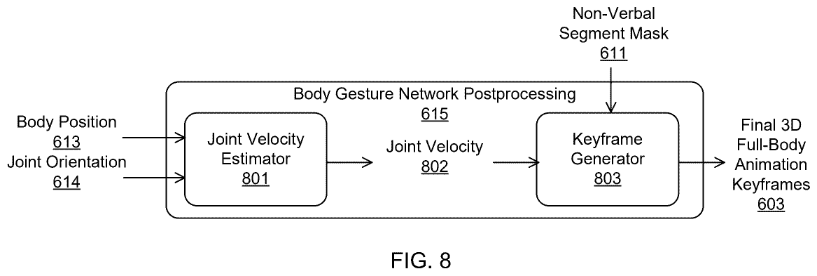

FIG. 8 illustrates example body gesture post-processing 615 in FIG. 6 in greater detail for explaining how synchronization between facial expressions and body gestures can be achieved in accordance with this disclosure. For ease of explanation, the body gesture post-processing 615 is described as being implemented within the server 106 (during training) and the electronic device 101 (during operation) in the network configuration 100 of FIG. 1. However, the body gesture post-processing 615 may be implemented using any other suitable device(s) and in any other suitable system(s).

In the platform 311, the audio features 315 predicted by the audio encoder 313 can be shared between facial expression generation by the voice processing network 318 and full-body animations by the body gesture network 319. To achieve synchronization between facial expressions and body gestures in the pipeline 300, the voice processing network 318 and the body gesture network 319 can share a common audio encoder 313 to ensure that both modules share the same audio information (audio features 315) including MFCCs and prosodic features, such as speech intensity, pitch, and the corresponding derivatives. Consequently, the intensity of output face and body animations can follow a pattern similar to the extracted speech features.

The voice processing network 318 can predict the word/phoneme boundaries 608, which allows the mask generator 610 to effectively identify non-verbal segments 705, 706 from the audio input waveform 701 and create a binary non-verbal segment mask 611 for non-verbal segments of the speech. In the post-processing 615, a joint velocity estimator 801 can calculate a velocity of body joints 802, such as by subtracting each joint's positions between consecutive pairs of frames. A keyframe generator 803 can take the velocity or velocities of the body joints 802, along with the non-verbal segment mask 611, and use a fade-out mask on the gesture speed, such as by smoothing trailing edges. As a result, at the transition from a verbal segment to a non-verbal segment, gesture speed may gradually be reduced to zero. Consequently, the resulting body gesture speed can better align with mouth movements. That is, the avatar's body can remain still when the avatar's mouth is still. The keyframe generator 803 can update the body positions 613 and joint orientations 614, producing the final 3D full-body animation keyframes 603.

Although FIG. 8 illustrates one example of a body gesture post-processing 615 in FIG. 6 in greater detail for explaining how synchronization between facial expressions and body gestures can be achieved, various changes may be made to FIG. 8. For example, other techniques could be employed to mask gesture speeds during transitions between verbal and non-verbal segments of speech.

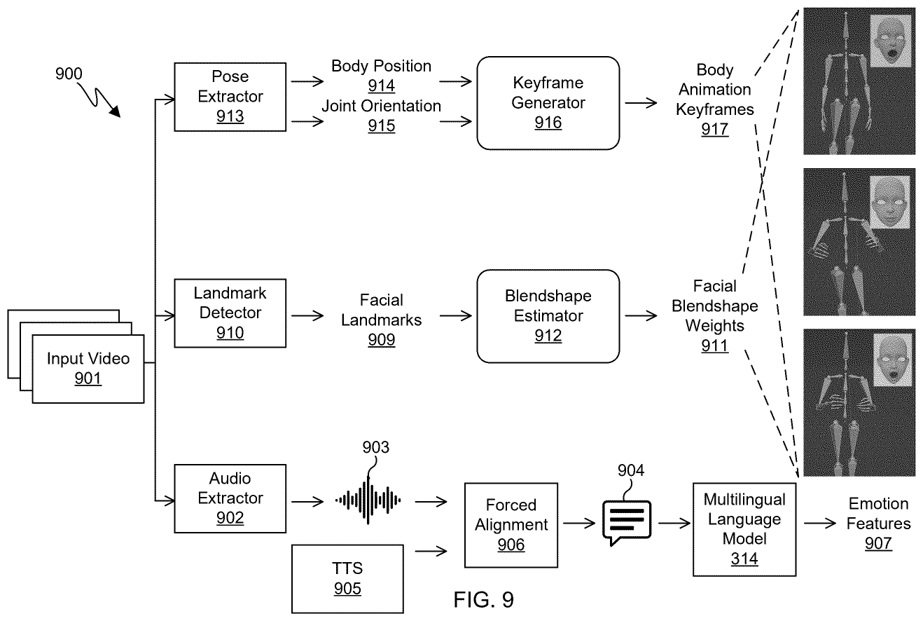

FIG. 9 illustrates example training dataset collection 900 for joint training of machine learning models to achieve synchronization between facial expressions and body gestures in accordance with this disclosure. More specifically, FIG. 9 illustrates training dataset collection for joint training of the voice processing network 318 and the body gesture network 319 to achieve synchronization between facial expressions and body gestures. For ease of explanation, the training dataset collection 900 is described as being implemented within the server 106 in the network configuration 100 of FIG. 1. However, the training dataset collection 900 may be implemented using any other suitable device(s) (such as the electronic device 101) and in any other suitable system(s).

For purposes of joint training, at least one training dataset can be collected that includes a synchronized set of facial expressions and body gestures, along with corresponding audio and text. For example, in some cases, a publicly-available video dataset that captures humans with both faces and bodies may be used. Segments of image video frames 901 can be selected from the video dataset. An audio extractor 902 can extract audio 903 (such as in *.wav format files) from each video recording and generate aligned text 904 using TTS 905 and a forced alignment tool 906 (such as Montreal forced aligner (MFA)). For emotion features 907, the aligned text 904 can be annotated with emotions, such as by using a multilingual language model 314. The multilingual language model 314 can be independently trained on at least one training dataset that includes text annotated with emotion features 907, such as various emotion types and corresponding intensity levels.

For human faces detected within the image video frames 901, phonemes can be aligned using the forced alignment tool 906, and facial landmarks 909 can be detected by a landmark detector 910 for use in estimating facial blendshape weights 911 by a blendshape estimator 912. For human bodies detected within the image video frames 901, a pose extractor 913 can extract body positions 914 and 3D orientations of body joints 915, which can be used by a keyframe generator 916 to generate body animation keyframes 917 (such as in BioVision Hierarchy (BVH) file format). In some cases, non-speech parts of audio can be collected from a public or other speech dataset and paired with idle face/body animations so that output animations are kept in synchronization with non-verbal segments of the audio.

Although FIG. 9 illustrates one example of training dataset collection 900 for joint training of machine learning models to achieve synchronization between facial expressions and body gestures, various changes may be made to FIG. 9. For example, the aligned text 904 may be manually annotated by a human with identifiers corresponding to emotion features 907.

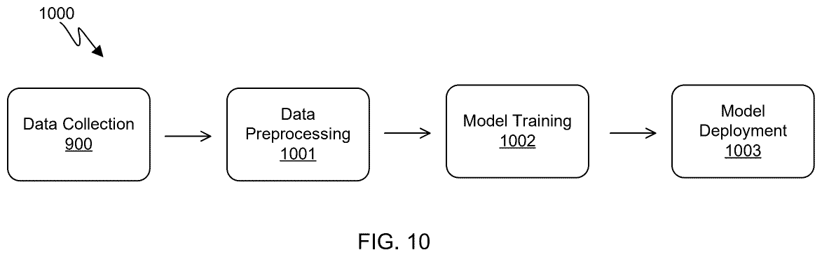

FIG. 10 illustrates an example process 1000 for model preparation for the platform 311 for avatar expression in accordance with this disclosure. For ease of explanation, the process 1000 is described as being implemented within the server 106 in the network configuration 100 of FIG. 1. However, process 1000 may be implemented using any other suitable device(s) (such as the electronic device 101) and in any other suitable system(s).

The process 1000 for model preparation in FIG. 10 begins with the training dataset collection 900 as described above in connection with FIG. 9. Data pre-processing 1001 can be performed on outputs of the pose extractor 913 to estimate body orientations from 3D coordinates, retarget to an XR-based body hierarchy, and smooth any noise in collected data. Model training 1002 can be performed on models built in, for example, Python using either TensorFlow or PyTorch as the development framework. Model training can include hyperparameter tuning to optimize performance. Example hyperparameters may include one or more of a number of layers, layer sizes, batch size, or dropout rate. During model deployment 1003, the models may be converted to lightweight versions and quantized for performance optimization.

Although FIG. 10 illustrates one example of a process 1000 for model preparation for the platform 311 for avatar expression, various changes may be made to FIG. 10. For example, data collection, data pre-processing, and model training may be performed iteratively.

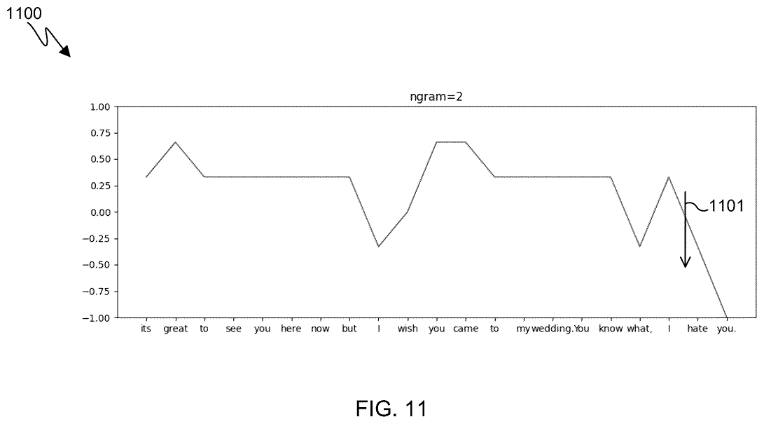

FIG. 11 illustrates example performance of the multilingual language model 314 of FIG. 3 in accordance with this disclosure. In the example of FIG. 11, a plot shows predicted intensity of identified emotion types (“joy” in the example shown) for each word in an input text. The multilingual language model 314 accurately predicts a sudden change 1101 in emotion intensity within the sentence.

Although FIG. 11 illustrates one example of performance of the multilingual language model 314 of FIG. 3, various changes may be made to FIG. 11. For example, while FIG. 11 illustrates one possible performance characteristic of the multilingual language model 314, those skilled in the art will understand that performance can vary based on the input and based on any number of additional factors.

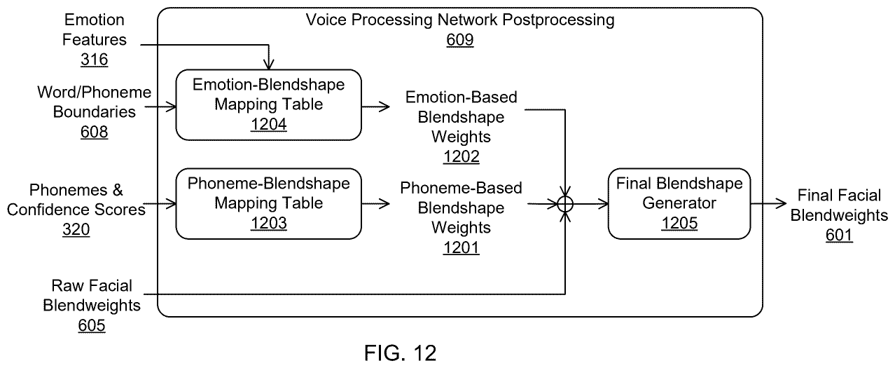

FIG. 12 illustrates example post-processing 609 by the voice processing network 318 of FIG. 3 in greater detail in accordance with this disclosure. For ease of explanation, the post-processing 609 is described as being implemented within the server 106 (during training) and the electronic device 101 (during operation) in the network configuration 100 of FIG. 1. However, the post-processing 609 may be implemented using any other suitable device(s) and in any other suitable system(s).

The post-processing 609 here can be performed to enhance avatar face animation, such as by incorporating blendshape weights from predicted phonemes (phoneme-based blendshape weights 1201 corresponding to highly accurate lip-sync results), predicted raw blendshape weights 605 (corresponding to subtle facial expressions), and blendshape weights from emotion features (emotion-based blendshape weights 1202 corresponding to emotional expressions). As shown here, the phoneme-based blendshape weights 1201 can be determined from a phoneme-blendshape mapping table 1203 based on phonemes and confidence scores 320, the emotion-based blendshape weights 1202 can be determined from an emotion-blendshape mapping table 1204 based on emotion features 316 and word/phoneme boundaries 608, and the raw blendshape weights 605 may be used without any intermediate mapping.

A final blendshape generator 1205 can receive a concatenation or other combination of the phoneme-based blendshape weights 1201, the emotion-based blendshape weights 1202, and the predicted raw blendshape weights 605 and generate a weighted sum of blendshape weights as the final facial blendshape weights 601. In some cases, the final blendshape generator 1205 can use an adaptive technique to generate the weighted sum of blendshape weights, such as an adaptive technique defined as follows.

$$S := β {S}_{e} + ( 1 - β ) * \{ α * p * {S}_{v} + ( 1 - α ) * {S}_{f} \}$$

Here, Sₑ represents the emotion-based blendshape weights 1202 converted from the emotion-blendshape mapping table 1204, Sy represents the phoneme-based blendshape weights 1201 converted from the phoneme-blendshape mapping table 1203, Sf represents the predicted raw blendshape weights 605, p represents the confidence score of the predicted phoneme in the phonemes and confidence scores 320, and α, β are hyperparameters (such as hyperparameters with constraints of 0≤α≤1 and 0≤β≤1, such as α=0.3 and β=0.25). The post-processing 609 can thereby enable the generation of avatar face animations with highly-accurate lip-sync, blended with subtle expressions aligned with the emotions conveyed in the avatar's speech.

Although FIG. 12 illustrates one example of post-processing 609 by the voice processing network 318 of FIG. 3, various changes may be made to FIG. 12. For example, the phoneme-blendshape mapping table and the emotion-blendshape mapping table may be interdependent, where one depends on the other.

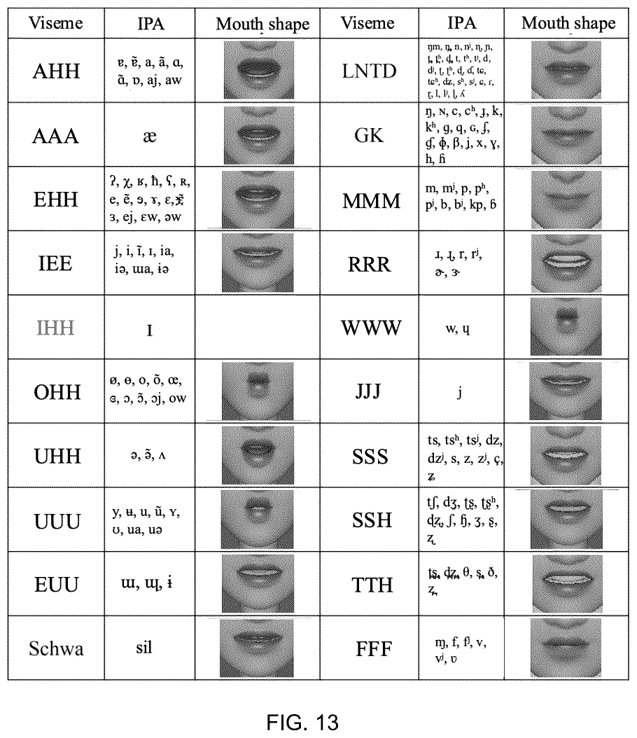

FIG. 13 illustrates an example phoneme-blendshape mapping table in accordance with this disclosure. In this example, each International Phonetic Alphabet (IPA) phoneme is matched with a mouth shape (also called a viseme or visual description of a phoneme in spoken language that defines the position of the face and mouth while a person is speaking). These can be converted into facial blendshape weights. Similarly, in emotion-based blendshape weights, each emotion can be matched with a set of templates of blendshape weights. For each emotion, blendshape can be randomly selected from the template.

Although FIG. 13 illustrates one example of a phoneme-blendshape mapping table, various changes may be made to FIG. 13. For example, those skilled in the art will understand that variants may be employed with more or fewer phonemes (and/or specific to different emotions).

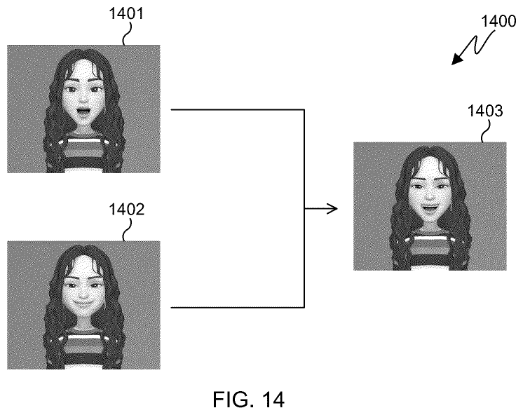

FIG. 14 illustrates an example of blending 1400 based on blendshape weights in accordance with this disclosure. In FIG. 14, blendshape weights for a mouth shape 1401 of an “AHH” viseme are combined with blendshape weights for facial characteristics 1402 corresponding to an emotion “JOY” to generate a combined mouth shape and facial characteristics 1403 for the AHH viseme with the JOY emotion.

Although FIG. 14 illustrates one example of blending 1400 based on blendshape weights, various changes may be made to FIG. 14. For example, those skilled in the art will understand that many variants representing different combinations of visemes and emotions exist.

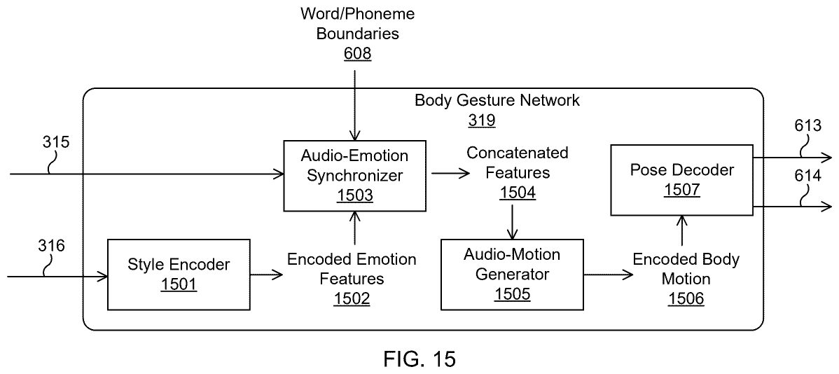

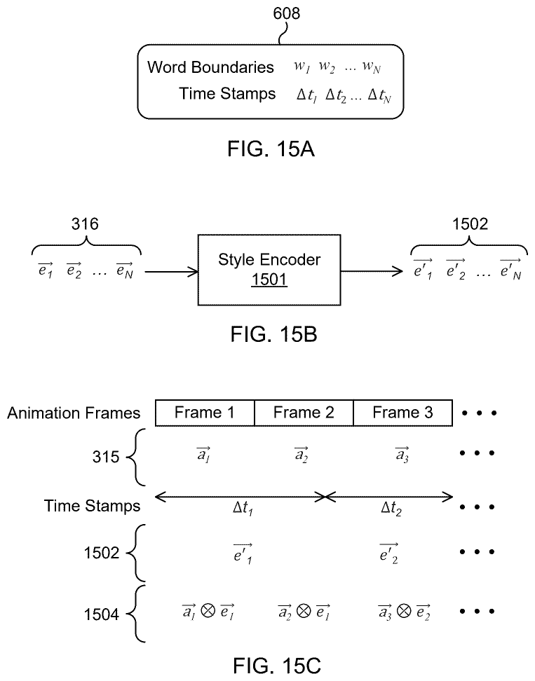

FIGS. 15 and 15A-15C illustrate an example body gesture network 319 of FIG. 3 in greater detail in accordance with this disclosure. For ease of explanation, the body gesture network 319 is described as being implemented within the server 106 (during training) and the electronic device 101 (during operation) in the network configuration 100 of FIG. 1. However, the body gesture network 319 may be implemented using any other suitable device(s) and in any other suitable system(s).

In some cases, the body gesture network 319 may represent an on-device ML model that outputs body positions 613 and joint orientations 614 from audio features 315 and emotion features 316, as well as word/phoneme boundaries 608. Example components of the body gesture network 319 here may include a style encoder 1501, such as one implemented as a DNN or other ML model, that receives the emotion features 316 and generates encoded emotion features 1502; an audio-emotion synchronizer 1503 that receives the audio features 315 and the encoded emotion features 1502 and generates (audio-emotion) concatenated features 1504; an audio-motion generator 1505 that receives the concatenated features 1504 and generates encoded body motion 1506; and a pose decoder 1507, such as one implemented as a DNN or other ML model, that receives the encoded body motion 1506 and generates body position 613 and joint orientation 614.

FIG. 15A illustrates an example of word/phoneme boundaries 608. Word boundary information includes word tokens w₁ w₂ . . . w_{N} and the corresponding time stamps (start and end times or duration Δt). FIG. 15B illustrates an example of the operation of the style encoder 1501. The multilingual language model 314 here may generate an emotion feature vector è=\vec{e₁} \vec{e₂} . . . \vec{e_{N}} (emotion type and intensity values) for each word token w, and each emotion feature vector can be matched with time range information Δt from the word boundary information. The style encoder 1501 can compress and transform the resulting emotion feature vectors è into a smaller representation, which creates encoded emotion features 1502 \vec{e′}.

FIG. 15C illustrates an example of the operation of the audio-emotion synchronizer 1503. The audio-emotion synchronizer 1503 here combines audio features 315 and encoded emotion features 1502 to generate a single series of inputs, such as at a fixed animation frame rate. From the audio encoder 313, each audio feature vector \vec{a} can be assigned to each animation frame. With the encoded emotion feature vector \vec{e′} (where each \vec{e_{ι}′} is associated with a specific time duration Δt), the audio-emotion synchronizer 1503 can align \vec{e′} with the animation frames based on the respective durations and can concatenate or otherwise combine \vec{a} with corresponding \vec{e′}.

The pose decoder 1507 can include a single feedforward layer that reconstructs body positions and joint orientations from latent motion representations (encoded body motions). Both audio embeddings and desired emotion embeddings can be provided to the model, and therefore the output motions can follow audio rhythms and reflect emotion characteristics learned during training. For example, for the emotion type “anger,” generated hand gestures may generally be faster and reflect greater motion ranges.

During the training dataset collection 900, body poses may be extracted from input videos using the pose extractor 913. The audio extractor 902 can extract corresponding audio in the video clip, and TTS and a forced alignment tool can be used to obtain aligned text transcripts. With a pre-trained multilingual language model 314 (which may have been trained with an annotated text dataset with emotions), emotion feature embeddings used for body gesture generation model training can be obtained. The audio-emotion synchronizer 1503 can be trained synchronize extracted audio feature embeddings and emotion feature embeddings.

Although FIGS. 15 and 15A-15C illustrate one example of a body gesture network 319 of FIG. 3 in greater detail, various changes may be made to FIGS. 15 and 15A-15C. For example, the specifics of the individual models here may vary, such as in type, number, or other connection.

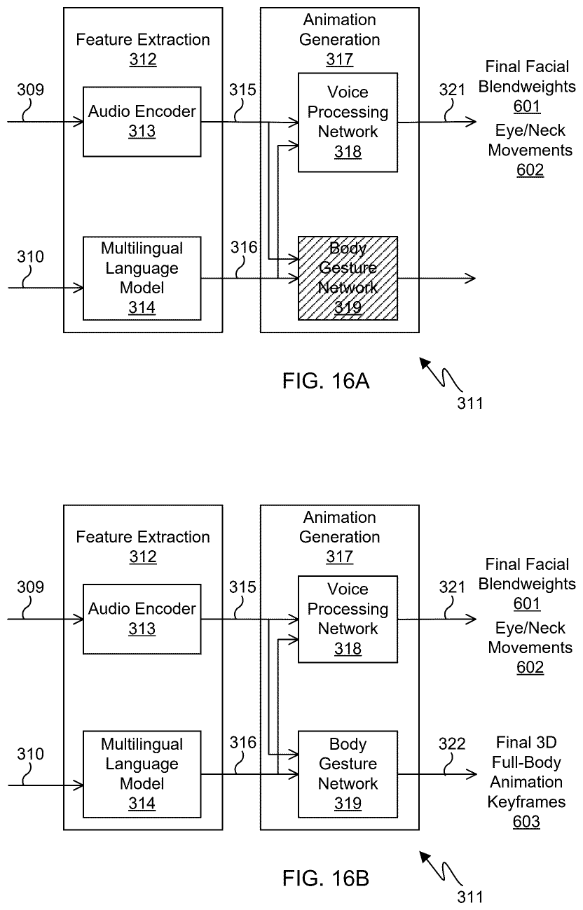

FIGS. 16A and 16B illustrate example modes of operation for the platform 311 for avatar expression in FIG. 3 in accordance with this disclosure. For ease of explanation, the modes of operation for the platform 311 are described relating to the electronic device 101 (during operation) in the network configuration 100 of FIG. 1. However, the modes of operation for the platform 311 may relate to any other suitable device(s) (such as the electronic device 102 or electronic device 104 or the server 106) and in any other suitable system(s).

In this example, the platform 311 for avatar expression supports at least two modes of operation. In a first mode of operation illustrated by FIG. 16A, head-only (or torso-only) animation of the 3D AI avatar may be provided. In this mode of operation, the body gesture network 319 could be disabled, or at least the outputs of the body gesture network 319 may be unused. In a second mode of operation illustrated by FIG. 16B, full body animation of the 3D AI avatar may be provided, in which case the body gesture network 319 can be enabled.

Although FIGS. 16A and 16B illustrate examples of modes of operation for the platform 311 for avatar expression in FIG. 3, various changes may be made to FIGS. 16A-16B. For example, more than two modes of operation may be supported, such as one or more intermediate modes in which portions of the avatar's body other than its head/torso are rendered without animation (remain fixed) or one or more modes of operation in which a user sets parameters to control the amount of motion allowed during animation (like small movements versus large movements) or the degree of emotion displayed (like subtle versus exaggerated).

Note that, in some cases, the feasibility of a real-time animation pipeline with emotions may be established by evaluating the total processing time on an existing mobile device. For example, for audio input, given a live audio stream split into buffers of fixed length (such as 120 ms), a streaming ASR engine may be run that produces text transcripts for each audio buffer. Given a 120 ms audio buffer, the average total processing time may be well below the buffer size (such as 37 ms). For text input, if an LLM streams output token-by-token and the output is immediately passed to a TTS model, the appropriate buffer length may be set, and both text and audio input can be fed to the model. An example for multilingual language model processing time can be about 40 ms per inference, which could be slow for real-time processing. However, in this example, the multilingual language model includes a two-phase classifier. After pre-processing of an input text 310 to tokenize the input text and group sequences of word pairs (such as into bigrams), a lexicon filter can pre-detect whether emotional content exists within the input text and pass only emotional lexicons to the model with a dictionary-based method (processing time>1 ms). If no emotional content is detected, the AI avatar can be presented with a neural emotion, and the input text used for other aspects of AI avatar generation. If emotional content is detected, the input text undergoes an embedding to generate numerical representations of the input text. In this manner, the multilingual language model can process the input text in real-time with low latency. In some embodiments, the ML models described here can be quantized for performance optimization and can be very lightweight, such as with a total model size under 20 megabytes (MB). TABLE 1 below provides example performance characteristics for a specific implementation of the pipeline described above.

TABLE 1

| | | | | | | Processing |
|---|---|---|---|---|---|---|
| Input | Processing | Processing Time | | | | Time |
| Length | Time | Facial | | | | Multilingual |
| Buffer | Audio | Expression | Gesture | Post- | | Language |
| Size | Encoder | Generation | Generation | Processing | Total | Model |
| 120 ms | 5 ms | 7 ms | 10 ms | 15 ms | 37 ms | 40 ms/inference |

In some cases, a body gesture generation model may be optimized for real-time processing, such as by incorporating (i) an efficient architecture with precisely-chosen layers and an ideal number of hidden units; (ii) a reduced input data size through optimized feature selection; (iii) batching and windowing techniques to handle smaller sequential elements; and (iv) quantization/compression techniques that preserve animation quality. To confirm that the model maintains quality when made more lightweight, quantitative metrics may be developed to measure errors against ground truth animations. Model size and complexity may be reduced without exceeding an acceptable error threshold. The model can maintain high quality when converted from one platform (operating system and resources) to another and quantized to lower bit without significant degradation.

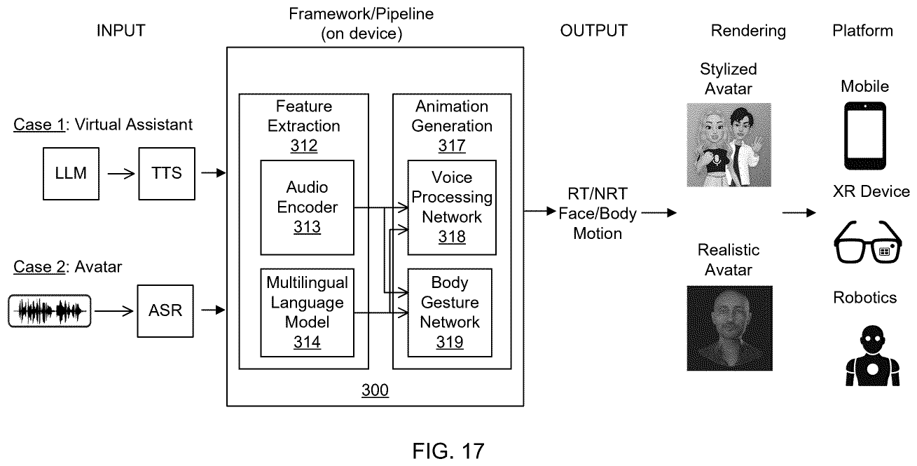

FIG. 17 illustrates example use cases for on-device multi-modal AI generation of synchronized face and full-body animation for a 3D avatar in accordance with this disclosure. For ease of explanation, the use cases of FIG. 17 are described as being implemented using the pipeline 300 shown in FIG. 3 for use with the electronic device 101 in the network configuration 100 of FIG. 1 operating in collaboration with the server 106. However, the use cases illustrated in FIG. 17 may be implemented using any other suitable architecture(s) in any suitable device(s) and/or suitable system(s). Also, the pipeline 300 may be used with other use cases.

Case 1 in FIG. 17 involves a visual (virtual) assistant in which a user interface for an AI LLM presents as an avatar and receives voice input, responding with TTS output. Case 2 in FIG. 17 involves user speech (received via a microphone and converted using speech-to-text) for a video conference being delivered via an AI avatar. Depending on the implementation, the avatar may be either stylized or realistic. Also, the output platform may be a mobile terminal, an XR device, a robotics device, or other suitable platform.

In some cases, the techniques described above can be particularly useful for users with XR devices, such as AR glasses. For instance, for Case 1, as LLM text output streams, a user wearing AR glasses and interacting with the LLM may be presented with synthetic audio and full-body 3D avatar generated with lip-sync and rendered for presentation on the AR glasses. For Case 2 (virtual avatar in video conferences), one user may communicate with another user (with or without AR glasses) and, as either user's voice streams, a full-body 3D avatar representation of that user can be generated and rendered for presentation on a suitable platform (such as a mobile device or XR device).

Although FIG. 17 illustrates examples of use cases for on-device multi-modal AI generation of synchronized face and full-body animation for a 3D avatar, various changes may be made to FIG. 17. For example, other or additional use cases may be supported for a given electronic device, including those involving variants of the use cases depicted or combinations thereof.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompasses such changes and modifications as fall within the scope of the appended claims.

What is claimed is:

1. A method comprising:
obtaining, using at least one processing device of an electronic device, input audio data and input text data;
extracting, using the at least one processing device, audio features from the input audio data using an audio encoder;
extracting, using the at least one processing device, emotion features for the input text data using a multilingual language model trained to classify emotion type and emotion intensity from text;
providing, using the at least one processing device, the audio features to a facial expression generation model trained to predict at least one of phonemes, phoneme/word boundaries for lip-sync activity, facial blendshape weights for facial expressions, iris movements and eye blink activity for eye movements, and orientation of a neck joint for head movements of an avatar;
determining, using the at least one processing device, final facial blendshape weights for a specified facial expression of the avatar based on at least one of the predicted phonemes, the predicted facial blendshape weights, and the emotion features;
providing, using the at least one processing device, the audio features and the emotion features to a gesture generation model trained to predict at least one of a three-dimensional (3D) position of a body center and orientation of body joints;
generating, using the at least one processing device, final 3D full-body animation keyframes of body gestures of the avatar based on at least one of the predicted phoneme/word boundaries, the predicted 3D position of the body center, and the predicted orientation of the body joints; and
playing, using the at least one processing device, the input audio data and synchronously presenting the final facial blendshape weights and the final 3D full-body animation keyframes.

2. The method of claim 1, further comprising:
receiving a selection of an application mode from a user, wherein:
in a first application mode, the input audio data comprises user-provided audio, and the input text data is generated from the user-provided audio using automatic speech recognition (ASR);
in a second application mode, the input text data comprises user-provided text, and the input audio data is generated from the user-provided text using text-to-speech (TTS); and
in a third application mode, the input text data comprises a text response to a user inquiry from an on-device large language model (LLM), and the input audio data is generated from the text response using TTS; and
receiving a selection for an avatar mode from the user, wherein:
a first avatar mode corresponds to 3D avatar animation for only a head of the avatar, wherein the facial expression generation model is trained to generate final 3D head animation keyframes based on the predicted orientation of the neck joint and the gesture generation model is disabled in the first avatar mode;
a second avatar mode corresponds to 3D avatar animation for the head and an upper body of the avatar, wherein the predicted orientation of the neck joint from the facial expression model is overwritten by the orientation of all body joints, including head and neck joints, predicted by the gesture generation model in the second avatar mode; and
a third avatar mode corresponds to 3D avatar animation for the head and a full body of the avatar, wherein the predicted orientation of the neck joint from the facial expression model is overwritten by the orientation of all body joints, including head and neck joints, predicted by the gesture generation model in the third avatar mode.

3. The method of claim 1, wherein determining the final facial blendshape weights of the avatar and generating the final 3D full-body animation keyframes comprise synchronizing body motion intensity with the lip-sync activity.

4. The method of claim 3, wherein:
the facial expression generation model and the gesture generation model are trained using audio features from a common audio encoder based on a synchronized dataset comprising facial expressions corresponding to the phonemes and the facial blendshape weights, body gestures corresponding to 3D animation keyframes, and corresponding audio and text; and
synchronizing the body motion intensity with the lip-sync activity comprises:
synchronizing body gesture speeds with the predicted phoneme/word boundaries; and
generating facial expressions and body gestures at a common frame rate, the common frame rate adjustable by a user.

5. The method of claim 1, wherein extracting the emotion features for the input text data comprises:
filtering emotion lexicons from the input text data using a pre-defined dictionary;
predicting emotion types and emotion intensities of the emotion lexicons; and
distributing the emotion types and emotion intensities across the animation keyframes at a user-specified frame rate.

6. The method of claim 5, wherein the predicted facial blendshape weights are first facial blendshape weights, and wherein generating the specified facial expression of the avatar comprises:
predicting the phonemes, the phoneme/word boundaries, and corresponding confidence scores from the audio features;
converting the predicted phonemes into second facial blendshape weights;
converting the emotion types and emotion intensities into third facial blendshape weights; and
determining the final facial blendshape weights based on an adaptive weighted sum of the first facial blendshape weights, the second facial blendshape weights, and the third facial blendshape weights.

7. The method of claim 5, wherein the gesture generation model is configured to:
predict encoded avatar motion from the audio features and an encoded style from the emotion types and emotion intensities;
use the encoded avatar motion to generate raw 3D full-body animation keyframes of the body gestures of the avatar; and
condition motion generation based on the encoded style.

8. The method of claim 1, wherein:
the input text data comprises a text response to a user inquiry from an on-device large language model (LLM); and
receiving the input text data comprises one of:
in a voice input mode, receiving the user inquiry via voice input, presenting the avatar in a listening mode in response to detecting voice activity of a user, detecting an end of the user inquiry in response to detecting voice inactivity of the user, converting the voice input into text using automatic speech recognition (ASR), forwarding the text to the on-device LLM, and receiving the text response from the on-device LLM; or
in a text input mode, receiving the user inquiry via text input, forwarding the text input to the on-device LLM, and receiving the text response from the on-device LLM.

9. The method of claim 8, wherein detecting the voice activity of the user comprises:
predicting phonemes with confidence scores by inputting the voice activity of the user into the facial expression generation model; and
determining if non-silence phonemes are predicted above a confidence threshold; and
wherein the listening mode for the avatar comprises:
presenting a predetermined idle avatar animation during the voice inactivity by the user;
presenting a predetermined listening avatar animation during the voice activity of the user; and
interpolating between the predetermined idle avatar animation and the predetermined listening avatar animation during the voice inactivity by the user and the voice activity of the user.

10. The method of claim 1, wherein the electronic device comprises at least one of:
a mobile device, an extended reality (XR) device, or a robot.

11. An electronic device comprising:
at least one processing device configured to:
obtain input audio data and input text data;
extract audio features from the input audio data using an audio encoder;
extract emotion features for the input text data using a multilingual language model trained to classify emotion type and emotion intensity from text;
provide the audio features to a facial expression generation model trained to predict at least one of phonemes, phoneme/word boundaries for lip-sync activity, facial blendshape weights for facial expressions, iris movements and eye blink activity for eye movements, and orientation of a neck joint for head movements of an avatar;
determine final facial blendshape weights for a specified facial expression of the avatar based on at least one of the predicted phonemes, the predicted facial blendshape weights, and the emotion features;
provide the audio features and the emotion features to a gesture generation model trained to predict at least one of a three-dimensional (3D) position of a body center and orientation of body joints;
generate final 3D full-body animation keyframes of body gestures of the avatar based on at least one of the predicted phoneme/word boundaries, the predicted 3D position of the body center, and the predicted orientation of the body joints; and
play the input audio data and synchronously presenting the final facial blendshape weights and the final 3D full-body animation keyframes.

12. The electronic device of claim 11, wherein the at least one processing device is further configured to:
receive a selection of an application mode from a user, wherein:
in a first application mode, the input audio data comprises user-provided audio, and the at least one processing device is configured to generate the input text data from the user-provided audio using automatic speech recognition (ASR);
in a second application mode, the input text data comprises user-provided text, and the at least one processing device is configured to generate the input audio data from the user-provided text using text-to-speech (TTS); and
in a third application mode, the input text data comprises a text response to a user inquiry from an on-device large language model (LLM), and the at least one processing device is configured to generate the input audio data from the text response using TTS; and
receive a selection for an avatar mode from the user, wherein:
a first avatar mode corresponds to 3D avatar animation for only a head of the avatar, wherein the facial expression generation model is trained to generate final 3D head animation keyframes based on the predicted orientation of the neck joint and the gesture generation model is disabled in the first avatar mode;
a second avatar mode corresponds to 3D avatar animation for the head and an upper body of the avatar, wherein the at least one processing device is configured to overwrite the predicted orientation of the neck joint from the facial expression model with the orientation of all body joints, including head and neck joints, predicted by the gesture generation model in the second avatar mode; and
a third avatar mode corresponds to 3D avatar animation for the head and a full body of the avatar, wherein the at least one processing device is configured to overwrite the predicted orientation of the neck joint from the facial expression model with the orientation of all body joints, including head and neck joints, predicted by the gesture generation model in the third avatar mode.

13. The electronic device of claim 11, wherein, to determine the final facial blendshape weights of the avatar and generate the final 3D full-body animation keyframes, the at least one processing device is configured to synchronize body motion intensity with the lip-sync activity.

14. The electronic device of claim 13, wherein:
the facial expression generation model and the gesture generation model are trained using audio features from a common audio encoder based on a synchronized dataset comprising facial expressions corresponding to the phonemes and the facial blendshape weights, body gestures corresponding to 3D animation keyframes, and corresponding audio and text; and
to synchronize the body motion intensity with the lip-sync activity, the at least one processing device is configured to:
synchronize body gesture speeds with the predicted phoneme/word boundaries; and
generate facial expressions and body gestures at a common frame rate, the common frame rate adjustable by a user.

15. The electronic device of claim 11, wherein, to extract the emotion features for the input text data, the at least one processing device is configured to:
filter emotion lexicons from the input text data using a pre-defined dictionary;
predict emotion types and emotion intensities of the emotion lexicons; and
distribute the emotion types and emotion intensities across the animation keyframes at a user-specified frame rate.

16. The electronic device of claim 15, wherein the predicted facial blendshape weights are first facial blendshape weights, and wherein, to generate the specified facial expression for the avatar, the at least one processing device is configured to:
predict the phonemes, the phoneme/word boundaries, and corresponding confidence scores from the audio features;
convert the predicted phonemes into second facial blendshape weights;
convert the emotion types and emotion intensities into third facial blendshape weights; and
determine the final facial blendshape weights based on an adaptive weighted sum of the first facial blendshape weights, the second facial blendshape weights, and the third facial blendshape weights.

17. The electronic device of claim 16, wherein the gesture generation model is configured to:
predict encoded avatar motion from the audio features and an encoded style from the emotion types and emotion intensities;
use the encoded avatar motion to generate raw 3D full-body animation keyframes of the body gestures of the avatar; and
condition motion generation based on the encoded style.

18. The electronic device of claim 11, wherein:
the input text data comprises a text response to a user inquiry from an on-device large language model (LLM); and
to receive the input text data, the at least one processing device is configured to one of:
in a voice input mode, receive the user inquiry via voice input, present the avatar in a listening mode in response to detecting voice activity of a user, detect an end of the user inquiry in response to detecting voice inactivity of the user, convert the voice input into text using automatic speech recognition (ASR), forward the text to the on-device LLM, and receive the text response from the on-device LLM; or
in a text input mode, receive the user inquiry via text input, forward the text input to the on-device LLM, and receive the text response from the on-device LLM.

19. The electronic device of claim 18, wherein, to detect the voice activity of the user, the at least one processing device is configured to:
predict phonemes with confidence scores by inputting the voice activity of the user into the facial expression generation model; and
determine if non-silence phonemes are predicted above a confidence threshold;
wherein, to present the avatar in the listening mode, the at least one processing device is configured to:
present a predetermined idle avatar animation during the voice inactivity by the user;
present a predetermined listening avatar animation during the voice activity of the user; and
interpolate between the predetermined idle avatar animation and the predetermined listening avatar animation during the voice inactivity by the user and the voice activity of the user.

20. The electronic device of claim 19, wherein the electronic device comprises at least one of: a mobile device, an extended reality (XR) device, or a robot.
